(19) United States
(12) Patent Application Publication
(10) Pub. No.: US 2022/0132753 A1
(43) Pub. Date: May 5, 2022

(54) Detention Profiles

(71) Applicants: Paul K. McMenamy, Fairview, OR (US); James Bruce` McMenamy, Damascus, OR (US)

(72) Inventors: Paul K. McMenamy, Fairview, OR (US); James Bruce` McMenamy, Damascus, OR (US)

(21) Appl. No.: 17/452,729

(22) Filed: Oct. 28, 2021

Related U.S. Application Data
(60) Provisional application No. 63/107,153, filed on Oct. 29, 2020.

(51) Int. Cl. A01G 13/10; A01M 29/30; A01M 29/12

(52) U.S. Cl. CPC A01G 13/105; A01M 29/12; A01M 29/30

(57) ABSTRACT

The invention provides an invertebrate pest detention profile for an extruded channel of rigid or flexible material which may be deployed as a partial or open contour, or a closed contour to establish a defensive line or perimeter to prevent crawling pests or invertebrates such as slugs from traversing the line or boundary. The profile provides a moat for offering a liquid or viscous attractant which retains pests by intoxication, or simply provides a shape too complex for them to overcome. The detention profile disclosed herein may be a component fitted to or incorporated within a garden pot, or built up from components of a pot for a garden plant to deny invertebrates or crawling pests access to a plant in the pot. The detention profile also hides the pests from immediate view and hinders access to them by pets or children.

### CROSS REFERENCE TO RELATED APPLICATON

This non-provisional utility application claims the benefit of and priority to U.S. Provisional Application 63/107,153“Detention Profile,” filed 29 Oct. 2020. The entire contents of U.S. Provisional Application 63/107,153 “Detention Profile,” filed 29 Oct. 2020, are hereby incorporated into this document by reference.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The invention relates to products which provide a moat which may be used to define a perimeter which invertebrate pests such as slugs are unable to traverse.

### BACKGROUND

Gastropods are invertebrates commonly known as slugs, and the term also includes snails and whelks. Many sorts of gastropods are garden pests that people find inherently unpleasant, and they may be especially destructive to delicate low hanging crops such as strawberries. Common methods of combatting gastropods include depositing irritant chemicals within an are to be protected, or making home made traps such as disposable plastic cups buried to ground level and filled with an attractant liquid such as cheap beer. However, depending on the approach path, gastropods may encounter the plants they seek to feed upon before encountering such a deterrent or an in-ground trap.

Most such traps are unsightly in that they allow passers by to see the trapped invertebrate pests dying or dead in the attractant liquid, and repurposed disposable articles may look out of place in hobby gardens of exquisite neighborhoods. Chemicals deposited on soils may leave unwanted residues when it is desired to grow other plants which may be sensitive to Por retarded by the products or their residues.

Children and pets may observe and have immediate access to dead or dying pests, or to long-stale beer left outside in cups. It would be preferred for an invention to eliminate these inadequacies.

### BRIEF DESCRIPTION

A primary objective of the invention is to provide a barrier which invertebrate or crawling pests cannot traverse. A corollary objective of the invention is to provide a profile for a longitudinal or arcuate channel or a ring, which may be deployed to establish a partial or a closed contour defining such a barrier. Another corollary objective of the invention is to provide pots and planters which incorporate the inventive the pest trap profile.

Another objective of the invention is to provide a reservoir for an attractant and especially a liquid attractant. A corollary objective of the invention is to recuse the reservoir from immediate view and access, so that animals and curious children are less likely to investigate and possibly come into contact with the trapped pests or the attractant.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows an oblique view of an embodiment of a detention assembly in accordance with the invention in which two annular elements assemble to form a detention profile.

FIG. 2 shows the two annular elements spaced apart to reveal interior features for further discussion.

FIG. 3a shows a half sectional view of the annular embodiment of FIG. 1.

FIG. 3b shows a cross section of an alternative embodiment of a detention profile in accordance with the invention.

FIG. 3c shows a cross section of an another alternative embodiment of a detention profile in accordance with the invention.

FIG. 4a shows an extruded product having a detention profile in accordance with the invention, formed to create a perimeter for preventing invertebrate and crawling pests from traversing its boundary.

FIG. 4b shows a mitered corner formed from two abutted extrusions having a detention profile in accordance with the invention.

FIG. 5a shows an alternative embodiment of an extrusion having a detention profile in accordance with the invention.

FIG. 5b shows an enlarged portion of the extruded profile of FIG. 5a.

FIG. 6a shows a detention assembly in accordance with the invention.

FIG. 6b shows a cut-away view of the detention assembly of FIG. 6a.

FIG. 6c shows a half sectional view of the detention assembly of FIG. 6a, with the components spaced apart for discussion.

FIG. 7a shows an alternative embodiment of a detention assembly in accordance with the invention which is a split ring that includes a clasp.

FIG. 7b shows another alternative embodiment of a detention assembly in accordance with the invention comprised of a series of detention profile segments coupled to each other to form a detention ring.

FIG. 8 shows a set of detention profile segments of FIG. 7b in a nested arrangement for compact packaging or storage.

FIG. 9 shows another alternative embodiment of a detention assembly in accordance with the invention in which an eave section and a moat section are conjoined by a hinge.

### DETAILED DESCRIPTION of CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise, and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The invention relates to traps for invertebrate and crawling pests. The traps share a common improvement called in this specification a detention profile. The inventive profile is serviceable for an extruded channel of rigid or flexible material which may be deployed as a partial or open contour, or the profile may be used in products having a closed contour so as to establish a defensive line or perimeter halting invertebrate and crawling pests from traversing the line or boundary. The profile provides a moat for offering a liquid or viscous attractant which retains the pests by intoxication, and simply comprises a shape too complex for a gastropod to overcome. A pest detention profile may be a component fitted to or incorporated within, or built up from components of a pot for a garden plant to deny invertebrate and crawling pests access to the plant. The detention profile also hides the pests from immediate view and hinders access to them by pets or children.

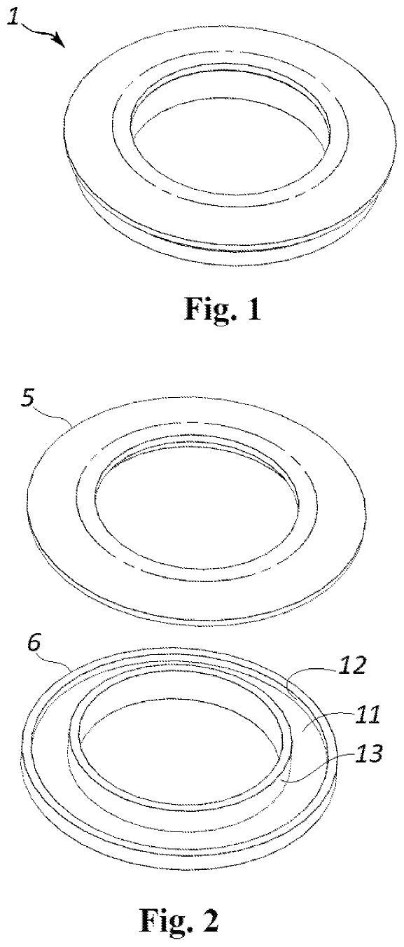

Referring to the figures, FIG. 1 shows an oblique view of an embodiment of a detention assembly [1] in accordance with the invention in which two annular elements assemble to form a detention profile.

FIG. 2 shows the two annular elements spaced apart to reveal interior features for further discussion. The two annular elements in this embodiment comprise a detention assembly with an eave component [5] and a moat component [6]. The moat component further comprises a first proximal wall [13], a distal wall [12], and a moat floor [11] spanning between the proximal wall and the distal wall. An attractant such as a liquid, a paste, a solid, or any other form of bait may be deposited in the moat. The distal rim of the eave extends at least to the distal wall of the moat and preferably extends beyond or overhangs the moat to keep the attractant shaded and to obscure dead or dying pests eating or drowning in the bait. Keeping these unsightly pests out of view lessens the chance that pets, other animals, or children attempt to access, play with, or eat them. The eave is separable from the moat so that the moat may be easily cleaned, the pests may be removed, and fresh bait may be deployed in the moat.

Another way to describe the invention is that the moat is an annular plate having an inner rim and an outer rim, and the eave is a ring having a flange overlapping the moat and an inner rim closely fitted to the inner rim of the moat.

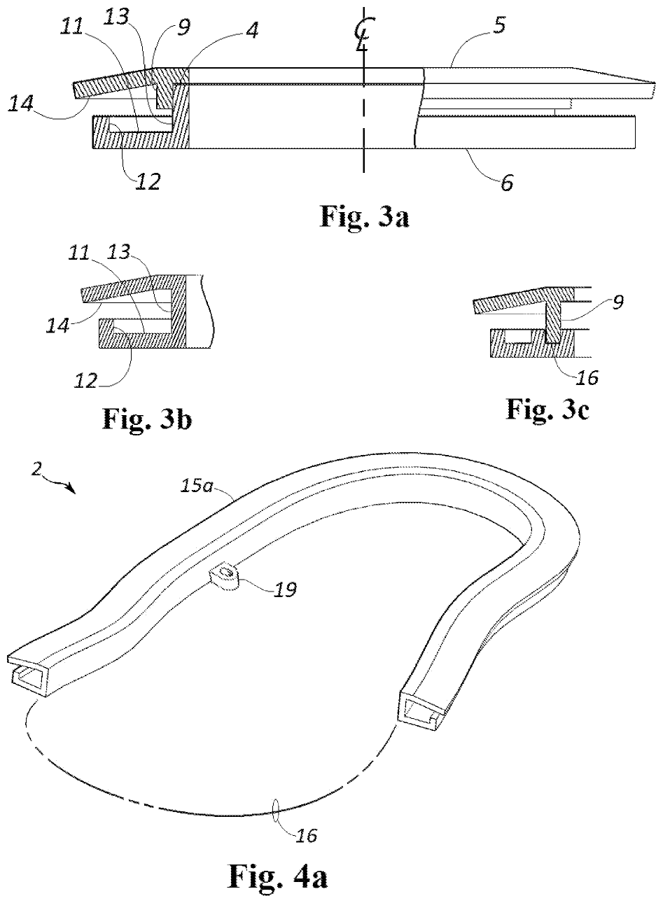

FIG. 3a shows a half sectional view of the annular embodiment of FIG. 1. The eave component [5] fits over the moat component [6]. The moat component further comprises a first proximal wall [13], a distal wall [12], and a moat floor [11] spanning between the proximal wall and the distal wall. The distal wall has a first height, and the first proximal wall has a second height greater than the first height. The eave component has a second proximal wall [9] and an eave [14] distally extending from the second proximal wall at least to the distal wall of the moat. The distal rim or end of the eave extends at least to the distal wall of the moat and preferably extends beyond or overhangs the moat, and resides above the height of the distal wall. In this embodiment the eave includes a receiving feature complementary to the first proximal wall of the moat.

Generally, the invention in its several embodiments is designed to defend plants and especially their tender portions such as soft fruits, leaves, or shoots from attack by crawling, non-flying pests. In particular, gastropods are very destructive to shaded, low-lying fruit such as strawberries, lingon berries, and cloud berries and the like. Because the field of the invention involves the establishment of a boundary protecting soft, succulent, and defenseless plant tissues enclosed in an interior by excluding and preventing the incursion of wanton marauders outside the boundary, older and obscure words from the English lexicon of fortification architecture are exacting and appropriate in this specification although they may be less familiar to readers for whom English is not a first language. The rapidity of incursion of Norman French beginning in 1066 AD occurred because the insular defenders had very little to no knowledge of effective fortification architecture. Thus the English language became infused with Norman French words which stand today. Readers are thus expected to be or to become familiar with the meaning of the word “rabbet” from its etymology in military architecture and its corollary, contemporary meaning in joinery to best appreciate how the components of the invention fit together when assembled. With this term introduced, it is seen in the figure that the first proximal wall of the moat is received within a rabbet [4] formed by a second proximal wall [9] of the eave component of the assembly.

FIG. 3b shows a cross section of an alternative embodiment of a detention profile in accordance with the invention. The profile includes a distal wall [12] of a first height, a proximal wall [13] having a second height greater than the first height, a moat floor [12] spanning between the proximal and distal walls, and an eave [14] distally extending from the proximal wall at least to the distal wall. The eave has an end residing above the first height of the distal wall, and preferably extends beyond or overhangs the moat. This profile may be extruded along a circular contour to form an annular object which maybe manufactured by 3D printing or investment casting. For injection molding, the two-part embodiment of the previous figures may be more cost efficient to produce.

FIG. 3c shows a cross section of another alter-native embodiment of a detention profile in accordance with the invention. In this embodiment the proximal wall of the detention profile taller than the distal wall of the moat is a feature of the eave component and is a second proximal wall [9]. The moat component in this embodiment includes a receiving feature for the eave component which in this embodiment is a groove [16] for receiving the wall of the eave. Alternatively, the wall may be part of the moat and the eave comprises a receiving feature for the moat, such as a groove residing in the ceiling of the eave. Besides a rabbet or a groove, the receiving feature may be any of a number of features such as a rib, a flange, or a ferrule. Either component may also include snapping latches designed for permanent or for detachable, re-closable assemblies.

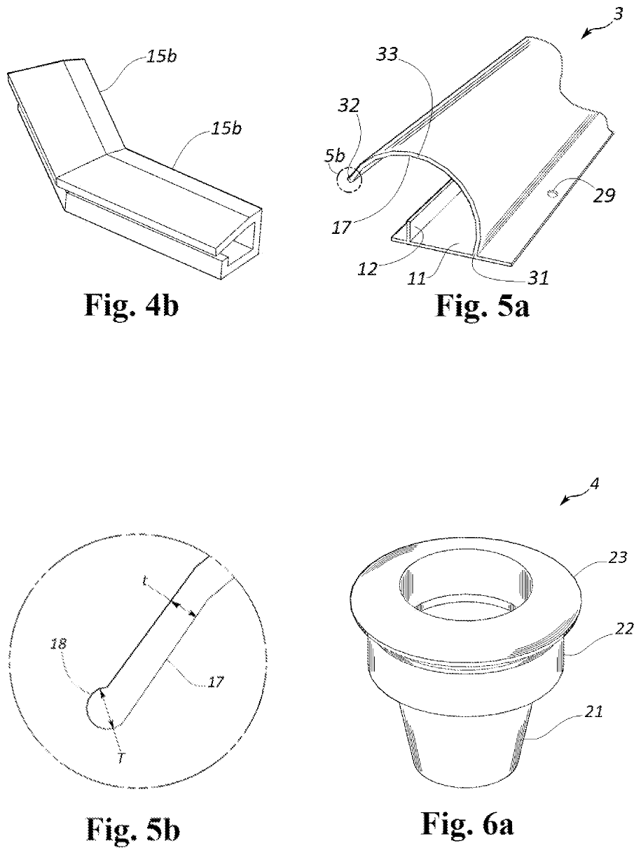

FIG. 4a shows an extruded product [2] having a detention profile in accordance with the invention, formed to create a perimeter for preventing invertebrate and crawling pests from traversing its boundary. This product is a channel providing the features set forth in FIG. 3b, and may be made from flexible, pliable, or rigid materials such as steel, aluminum, copper, bronze, a metal, a plastic, rubber, a urethane rubber, polyurethane, an elastomer, polycarbonate, acetal (Delrin®), acetate, acrylonitrilebutadiene styrene (ABS), a thermoplastic material, polystyrene, polyamide (nylon), polyimide, acrylic (Plexiglas®), polyacrylate, vinyl, or polyvinyl chloride (PVC).

The channel may be created by sweeping the detention profile along a contour which may be an arbitrary or decorative shape, to define a boundary for protected plants within and unwanted pests kept out. The contour is preferably a closed perimeter [16].

The channel may also be created by extruding the detention profile along a contour to form a beam [15a]. If the material is chosen to be pliable or plastically deformable, it may be furnished in straight lengths which consumers may cut to length and bend to form decorative or ornamental shapes. The channel may also be formed having one or a spaced series of perforated lugs [19] so that it may be anchored in place to preserve a particular shape or resist unwanted or accidental displacements.

FIG. 4b shows a mitered corner formed from two abutted extrusions [15b] having a detention profile in accordance with the invention. When formed out of more rigid material, the channel has a contour which is a straight line. If the attractant is a liquid rather than a paste or a solid, the interface of the mitered corners may be sealed with tape or a filler such as silicone rubber.

FIG. 5a shows an alternative embodiment [3] of an extrusion having a detention profile in accordance with the invention. This detention profile includes a distal wall [12] of a first height, an arcuate proximal wall [17] having a contour and a start point [31], an end point [32], and an intermediate point [33] along the contour between the start point and the end point. A moat floor [11] spans between the distal wall and the start point of the proximal wall, with the intermediate point residing above the first height of the distal wall. The end point resides at least as distal from the start point as the distal wall, but preferably the arcuate proximal wall overhangs the entire moat. The extrusion may include perforations along its length so that it may be staked in place or formed into a contour along the ground. The detail circle [5b] indicates a portion of this figure which is depicted as an enlargement in FIG. 5b.

FIG. 5b shows an enlarged portion of the extruded profile of FIG. 5a. Optional embodiments within the scope of the invention include that the distal end of an eave or an arcuate wall [17] terminate with a bead section [18], which may be a round or bulbous end or a step change in thickness, or any profile end feature such that the wall thickness of an eave or an arcuate proximal wall is a first thickness, and an end of the eave or arcuate proximal wall has a second thickness greater than the first thickness.

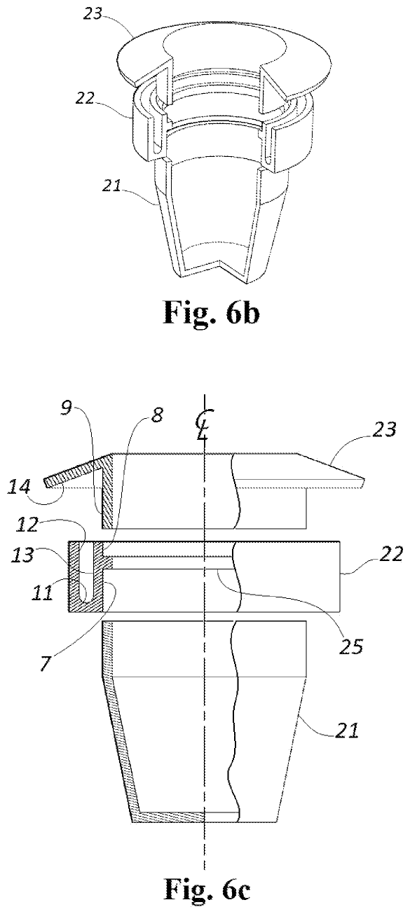

FIG. 6a shows a detention assembly in accordance with the invention similar to those shown in FIGS. 1 and 2 but also including a plant pot [21]. The moat component [22] and the eave component [23] stack up upon the rim of the pot. The moat and eave form a detention profile that girdles the entire circumference of the pot to deny access by invertebrate or crawling pests to the plants or the contents within the pot.

FIG. 6b shows a cut-away view of the detention assembly of FIG. 6a comprising an eave [23] a moat [22] and a pot [21]. The moat includes an inner flange so it may rest on the pot, and the proximal wall portion of the eave may also rest atop this same flange.

FIG. 6c shows a half sectional view of the detention assembly of FIG. 6a, with the components spaced apart for discussion. The detention assembly comprises a moat component [22] and an eave component [23], with the moat component comprising a first proximal wall [13], a distal wall [12], and a moat floor [11] spanning between the proximal wall and the distal wall. The moat floor may be broad or may form part of a deeper, narrower groove. The eave component includes a second proximal wall [9] and an eave [14] distally extending from the second proximal wall at least to the distal wall of the moat, but preferably the eave extends beyond or overhangs the moat. The end of the eave resides above a height of the distal wall of the moat. The detention profile provided by the assembled moat and eave components presents an insurmountable obstacle to most non-flying pests such as centipedes, caterpillars, gastropods or other invertebrates, because they lack the capability or intelligence to gain a purchase atop the eave from climbing up along the outside of the distal wall of the moat.

Besides a flange [25] or other feature for resting the moat onto the rim of the pot, the moat may include any other complementary receiving feature [8] for the second proximal wall of the eave, and in this figure the receiving feature is a rabbet. Alternatively the moat may include other receiving features for the eave, such as but not limited to a groove, a rib, a flange, or a ferrule.

According to an alternate embodiment in accordance with the invention, the engaging features of the moat and eave component may be reversed so that a rabbet, groove, rib, flange, ferrule or the like may reside in the eave component for fitting atop the moat component.

Similarly, engaging features for the moat and the pot may include a rabbet [7], groove, rib, flange, ferrule or the like residing on the moat for receiving a rim of the pot, or contrarily these features may reside in the pot as a receiving feature for the moat component.

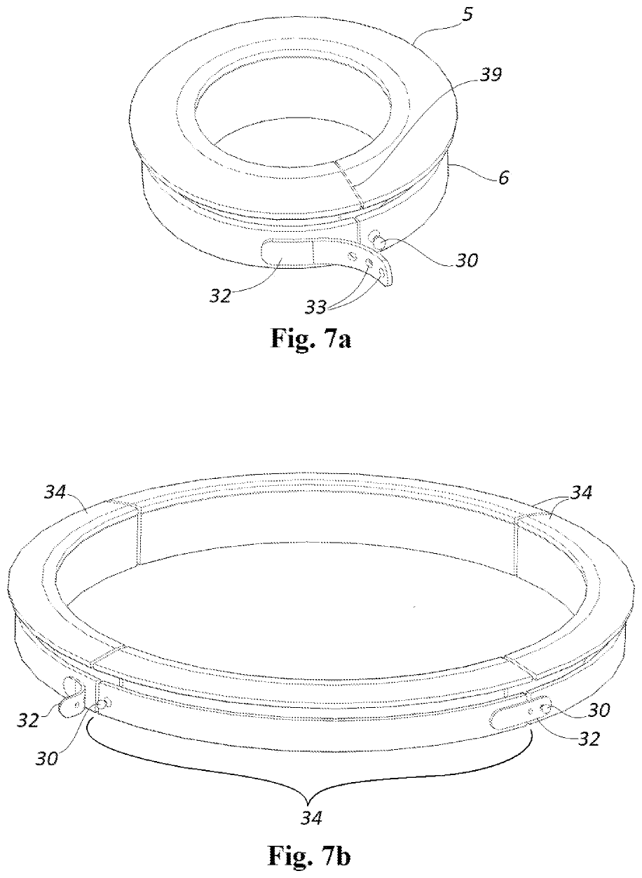

FIG. 7a shows an alternative embodiment of a detention assembly in accordance with the invention which is a split ring that includes a clasp. This embodiment is preferably made of a material which is at least slightly stretchy or elastomeric, such as natural, synthetic or urethane rubber, thermoplastic rubber (TPR), ethylene propylene diene monomer (EPDM) rubber, neoprene, nitrile, and preferably of a firmness between Shore A durometer 30 and 90 or Shore D durometer between 10 and 50. Because the invention is designed for outdoor use, any of various UV stabilizing agents are recommended. Flame retardants are also recommended, especially sufficient to impart a UL rating of ‘HB’ (horizontal burn) but with the more stringent vertical burn ratings being preferable if economically achievable.

The split [39] in the ring passes through both the eave component [5] and the moat component [6] to allow the ring to be opened and easily installed or removed from plant pots, and to allow the device to be used with pluralities of pots within a wider diameter tolerance range than the solid ring types. The ring components are closed around the girth of a plant pot using a clasp. According to one set of embodiments the clasp includes a perforated strap [32] having one or more apertures [33] and a hitch point or post [30]. In this embodiment and others, the clasp may also be made of an elastomeric material which is flexibly deformed as an aperture is hooked over the post. Other alternative clasps within the scope of the invention may include a perforated belt mated to a buckle, a strap passed through a pair of D-rings, an over-center latch, a snap hook, hook and loop (e.g, Velcro®)) closures, a flip closure, or a lobster-claw clasp. The eave and ring component may be affixed to each other as a manufacturing step or furnished as separable parts.

Because of the split, this kind of embodiment is less suited to liquid baits but may be used with pastes, gels, viscous matter, or solid particle baits. Salt grains are also useful for disabling gastropods trapped in the moat.

FIG. 7b shows another alternative embodiment of a detention assembly in accordance with the invention comprised of a series of arcuate detention profile segments [34] coupled to each other to form a detention ring. The detention profile may be an arcuate extrusion, or may be an assembly of an eave section and a moat segment. Each strap [32] of any one segment attaches to a hitch point [30] of an adjacent segment. Cleaning dead pests out of the segmented design is easier because the disconnected segments may be flushed out with a hose. Similarly, the split ring segment may be unclipped, distorted into a partial helix or an open arc, and then flushed out with a hose.

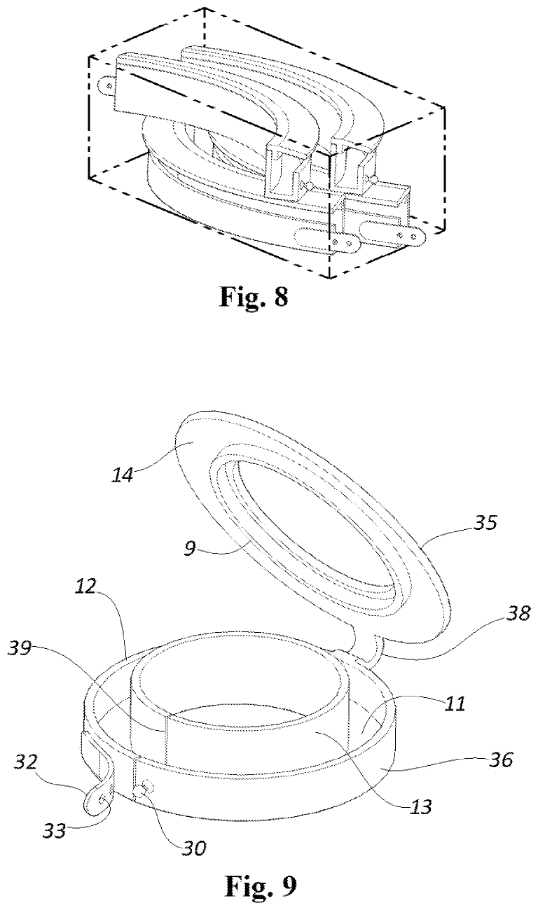

FIG. 8 shows a set of detention profile segments of FIG. 7b in a nested arrangement for compact packaging or storage within a parallelpiped shown in phantom lines. Here it is seen that compared to the wasted space consumed by a large hollow ring, the nested segments take up much less volume and, advantageously, will consume less shelf space in a retail setting.

FIG. 9 shows another alternative embodiment of a detention assembly in accordance with the invention in which an eave section [35] and a moat section [36] are conjoined by a hinge [38]. This embodiment may have its features oriented so that its entirety may be produced as a single injection-molded part in a single cavity. The moat section is split at [39] so that it may grip a wider range of plant pot diameters by means of a clasp, which in this embodiment includes a strap [32] having perforations [33], and a hitch point [30] which is a post with a bulbous head.

The moat section further comprises a first proximal wall [13], a distal wall [12], and a moat floor [11] spanning between the proximal wall and the distal wall. An attractant or poison in the form of a paste, a solid, or granules may be disposed in the moat. The underside surface of the eave section includes a second proximal wall [9] and an eave [14] distally extending from the second proximal wall. The distal rim of the eave extends radially at least to the distal wall of the moat and preferably extends beyond or overhangs the moat. When the eave section is capped onto the moat section to form a detention profile, the first and second proximal walls fit up one inside the other. This embodiment is convenient and easy to clean by flipping the eave section open to expose the moat section, which may then be flushed.

While certain features and aspects have been described with respect to exemplary embodiments, one skilled in the art will recognize that numerous modifications are possible. Also, while certain functionality is ascribed to certain system components, unless the context dictates otherwise, this functionality may be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Furthermore, the procedures described with respect to one method or process may be incorporated within other described methods or processes; likewise, system components described according to a particular structural configuration and/or with respect to one system may be organized in alternative structural configurations and/or incorporated within other described systems.

The present disclosure is not to be limited in terms of the particular embodiments described in this application, which are intended as illustrations of various aspects. Many modifications and variations may be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled.

Hence, while various embodiments are described with or without certain features for ease of description and to illustrate exemplary aspects of those embodiments, the various components and/or features described herein with respect to a particular embodiment may be substituted, added, and/or subtracted from among other described embodiments, unless the context dictates otherwise. Thus, unauthorized instances of apparatuses and methods claimed herein are to be considered infringing, no matter where in the world they are advertised, sold, offered for sale, used, possessed, or performed.

Consequently and in summary, although many exemplary embodiments are described above, it will be appreciated that the invention is intended to cover all modifications and equivalents within the scope of the following claims.

What is claimed is:

1. A detention profile comprising selected from the set of detention profiles consisting of:
a first detention profile comprising
a distal wall of a first height,
a proximal wall having a second height greater than said first height,
a moat floor spanning between said proximal and distal walls, and
an eave distally extending from said proximal wall at least to said distal wall, said eave having an end residing above said first height of said distal wall, and
a second detention profile comprising
a distal wall of a first height,
an arcuate proximal wall having a contour, a start point, an end point, and an intermediate point along said contour between said start point and said end point,
a moat floor spanning between said distal wall and said start point of said proximal wall,
with said intermediate point residing above said first height of said distal wall and said end point residing at least as distal from said start point as said distal wall.

2. The detention profile of claim 1, wherein said eave of said first detention profile further comprises a first thickness and an end of said eave further comprises a bead having a second thickness greater than said first thickness.

3. The detention profile of claim 1, wherein said arcuate proximal wall of said second detention profile further comprises a first thickness and an end of said arcuate proximal wall comprises a bead having a second thickness greater than said first thickness.

4. A channel providing a detention profile selected from among the set of detention profiles consisting of:
a first detention profile comprising
a distal wall of a first height,
a proximal wall having a second height greater than said first height,
a moat floor spanning between said proximal and distal walls, and
an eave distally extending from said proximal wall at least to said distal wall, said eave having an end residing above said first height of said distal wall, and
a second detention profile comprising
a distal wall of a first height,
an arcuate proximal wall having a contour, a start point, an end point, and an intermediate point along said contour between said start point and said end point,
a moat floor spanning between said distal wall and said start point of said proximal wall,
with said intermediate point residing above said first height of said distal wall and said end point residing at least as distal from said start point as said distal wall.

5. The channel of claim 4, wherein said eave of said first detention profile further comprises a first thickness and an end of said eave further comprises a bead having a second thickness greater than said first thickness.

6. The channel of claim 4, wherein said arcuate proximal wall of said second detention profile further comprises a first thickness and an end of said arcuate proximal wall comprises a bead having a second thickness greater than said first thickness.

7. The channel of claim 4, further comprising a material selected from the set of materials consisting of: steel, aluminum, copper, bronze, a metal, a plastic, rubber, a urethane rubber, polyurethane, an elastomer, polycarbonate, acetal, acetate, acrylonitrilebutadiene styrene, a thermoplastic material, polystyrene, polyamide, polyimide, acrylic, a polyacrylate, vinyl, and polyvinyl chloride.

8. The channel of claim 7, further comprising a perforated lug.

9. The channel of claim 4, wherein said detention profile is extruded along a contour to form a beam.

10. The channel of claim 9, wherein said contour is a straight line.

11. The channel of claim 4, wherein said detention profile is swept along a contour defining a closed perimeter.

12. A detention assembly comprising a moat component and an eave component, with
said moat component comprising a first proximal wall, a distal wall, and a moat floor spanning between said proximal wall and said distal wall, said eave component further comprising a second proximal wall and an eave distally extending from said second proximal wall at least to said distal wall of said moat, and said eave having an end residing above a height of said distal wall.

13. The detention assembly of claim 12, wherein said eave further comprises a receiving feature for said moat component.

14. The detention assembly of claim 13, wherein said receiving feature is selected from the set of features consisting of:
a groove, a rabbet, a rib, a flange, and a ferrule.

15. The detention assembly of claim 12, wherein said moat further comprises a receiving feature for said eave component.

16. The detention assembly of claim 15, wherein said receiving feature is selected from the set of features consisting of:
a groove, a rabbet, a rib, a flange, and a ferrule.

17. The detention assembly of claim 12, further comprising a pot.

18. The detention assembly of claim 17, wherein said pot further comprises a receiving feature for said moat component.

19. The detention assembly of claim 18, wherein said receiving feature for said moat component is selected from the set of features consisting of:
a groove, a rabbet, a rib, a flange, and a ferrule.

20. The detention assembly of claim 17, wherein said pot further comprises a receiving feature for said eave component.

21. The detention assembly of claim 20, wherein said receiving feature for said eave component is selected from the set of features consisting of:
a groove, a rabbet, a rib, a flange, and a ferrule.
